(19) United States
(12) Patent Application Publication
(10) Pub. No.: US 2025/0096402 A1
(43) Pub. Date: Mar. 20, 2025

(54) MULTI-LAYER COVER ASSEMBLY FOR BATTERY MODULE

(71) Applicant: GM Global Technology Operations LLC, Detroit, MI (US)

(72) Inventors: Anil Yadav, Troy, MI (US); Lakshman Venkatareddy, Karnataka (IN); Vicente Domenech Llopis, Shelby Township, MI (US)

(21) Appl. No.: 18/468,930

(22) Filed: Sep. 18, 2023

(51) Int. Cl. H01M 50/358; B60L 50/64; H01M 50/204; H01M 50/249; H01M 50/258; H01M 50/262; H01M 50/282

(52) U.S. Cl. CPC H01M 50/358; B60L 50/64; H01M 50/204; H01M 50/249; H01M 50/258; H01M 50/262; H01M 50/282; H01M 2220/20

(57) ABSTRACT

A battery assembly includes a housing having a base wall and a plurality of side walls that are connected to the base wall. The base wall includes a mid-line. A plurality of battery modules is arranged between the mid-line and one of the plurality of side walls. Each of the plurality of battery modules includes an inboard end facing the mid-line and an outboard end facing the one of the plurality of side walls. A plurality of battery cells is arranged in each of the plurality of battery modules. A cover assembly is mounted on each of the plurality of battery modules. The cover assembly includes an inner cover member and an outer cover member spaced from and connected to the inner cover member. The outer cover member restricts gas flow from the plurality of battery cells to the outboard end.

### INTRODUCTION

The subject disclosure relates to the art of battery assemblies and, more particularly, to a multi-layer top cover for a battery module that forms part of a battery assembly.

Rechargeable battery systems often include multiple connected battery cells arranged in a housing to form a battery module. Multiple battery modules are connected and arranged in a housing to form a battery assembly. The battery assembly may be used to provide motive power to, for example, a vehicle such as an automobile. In such an environment, the battery assembly is connected to a load, such as a drive motor and a charge port that may be connected to a source of electric energy. The battery assembly discharges into the drive motor to provide power to the vehicle and is charged through the charge port.

When a battery assembly is cycled, that is going through periods of discharging into the load or being charged, heat is generated in the battery cells. If a battery cell is discharged too deeply, or recharged improperly, the heat generated damage the battery. Accordingly, it is desirable to provide a battery module with a system that limits heat spread through a battery assembly when a chemical reaction starts in a single battery cell.

### SUMMARY

A battery assembly, in accordance with a non-limiting example, includes a housing having a base wall and a plurality of side walls that are connected to the base wall. The base wall includes a mid-line. A plurality of battery modules is arranged between the mid-line and one of the plurality of side walls. Each of the plurality of battery modules includes an inboard end facing the mid-line and an outboard end facing the one of the plurality of side walls. A plurality of battery cells is arranged in each of the plurality of battery modules. A cover assembly is mounted on each of the plurality of battery modules. The cover assembly includes an inner cover member and an outer cover member spaced from and connected to the inner cover member. The outer cover member restricts gas flow from the plurality of battery cells to the outboard end.

In addition to one or more of the features described herein an intermediate cover member is arranged between the inner cover member and the outer cover member, the intermediate cover member including one or more vent openings.

In addition to one or more of the features described herein the outer cover member is spaced from the intermediate cover member.

In addition to one or more of the features described herein a gap having a width of about 10 mm is defined between the intermediate cover member and the outer cover member.

In addition to one or more of the features described herein the intermediate cover member is formed from a temperature resistant electrically insulative material.

In addition to one or more of the features described herein the outer cover member includes a surface extending across each of the plurality of battery cells, the surface includes a first end arranged at the inboard end, a second end arranged out the outboard end, a first side extending between the first end and the second end, and a second side extending between the first end and the second end, the second side being spaced from the first side.

In addition to one or more of the features described herein the outer cover member includes a first end wall extending from the first end of the surface, a first side wall extending from the first side of the surface, and a second side wall extending from the second side of the surface, the first end wall, the first side wall, and the second side wall channeling gases from the plurality of battery cells toward the second end.

In addition to one or more of the features described herein the inner cover member includes a surface portion extending across each of the plurality of battery cells, the surface portion includes a first end portion arranged at the inboard end, a second end portion arranged out the outboard end, a first side portion extending between the first end and the second end, and a second side portion extending between the first end portion and the second end portion, the second side portion being spaced from the first side portion by the surface portion.

In addition to one or more of the features described herein the inner cover member includes a first end wall member extending from the first end portion of the surface portion, a second end wall member extending from the first end portion of the surface portion, a first side wall member extending from the first side portion of the surface portion, a second side wall member extending from the second side portion of the surface portion, the first side wall member and the second side wall member being connected to the first side wall and the second side wall of the outer cover member.

In addition to one or more of the features described herein the second end of the surface includes a connector element connecting the outer cover member with one of the plurality of side walls of the housing.

A vehicle, in accordance with a non-limiting example, includes a body including a passenger compartment, a drive motor supported in the body, a rechargeable energy storage system including a battery assembly coupled to the body. The battery assembly includes a housing having a base wall and a plurality of side walls that are connected to the base wall. The base wall including a mid-line. A plurality of battery modules is arranged between the mid-line and one of the plurality of side walls. Each of the plurality of battery modules includes an inboard end facing the mid-line and an outboard end facing the one of the plurality of side walls. A plurality of battery cells is arranged in each of the plurality of battery modules. A cover assembly is mounted on each of the plurality of battery modules. The cover assembly includes an inner cover member and an outer cover member spaced from and connected to the inner cover member. The outer cover member restricts gas flow from the plurality of battery cells to the outboard end.

In addition to one or more of the features described herein an intermediate cover member is arranged between the inner cover member and the outer cover member, the intermediate cover member including one or more vent openings.

In addition to one or more of the features described herein the outer cover member is spaced from the intermediate cover member.

In addition to one or more of the features described herein a gap having a width of about 10 mm is defined between the intermediate cover member and the outer cover member.

In addition to one or more of the features described herein the intermediate cover member is formed from a temperature resistant electrically insulative material.

In addition to one or more of the features described herein the outer cover member includes a surface extending across each of the plurality of battery cells, the surface includes a first end arranged at the inboard end, a second end arranged out the outboard end, a first side extending between the first end and the second end, and a second side extending between the first end and the second end, the second side being spaced from the first side.

In addition to one or more of the features described herein the outer cover member includes a first end wall extending from the first end of the surface, a first side wall extending from the first side of the surface, and a second side wall extending from the second side of the surface, the first end wall, the first side wall, and the second side wall channeling gases from the plurality of battery cells toward the second end.

In addition to one or more of the features described herein the inner cover member includes a surface portion extending across each of the plurality of battery cells, the surface portion includes a first end portion arranged at the inboard end, a second end portion arranged out the outboard end, a first side portion extending between the first end and the second end, and a second side portion extending between the first end portion and the second end portion, the second side portion being spaced from the first side portion by the surface portion.

In addition to one or more of the features described herein the inner cover member includes a first end wall member extending from the first end portion of the surface portion, a second end wall member extending from the first end portion of the surface portion, a first side wall member extending from the first side portion of the surface portion, a second side wall member extending from the second side portion of the surface portion, the first side wall member and the second side wall member being connected to the first side wall and the second side wall of the outer cover member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly housing a plurality of battery modules including a multi-layer cover assembly, according to a non-limiting example;

FIG. 2 depicts the battery assembly and the plurality of battery modules including the multi-layer cover assembly, in accordance with a non-limiting example;

FIG. 3 is a disassembled glass view of the multi-layer cover assembly, in accordance with a non-limiting example;

FIG. 4 is a first end view of the multi-layer cover assembly of FIG. 3, in accordance with a non-limiting example; and

FIG. 5 is a second end view of view of the multi-layer cover assembly of FIG. 4.

### DETAILED DESCRIPTION

The following description is merely exemplary in nature and is not intended to limit the present disclosure, its application or uses. It should be understood that throughout the drawings, corresponding reference numerals indicate like or corresponding parts and features.

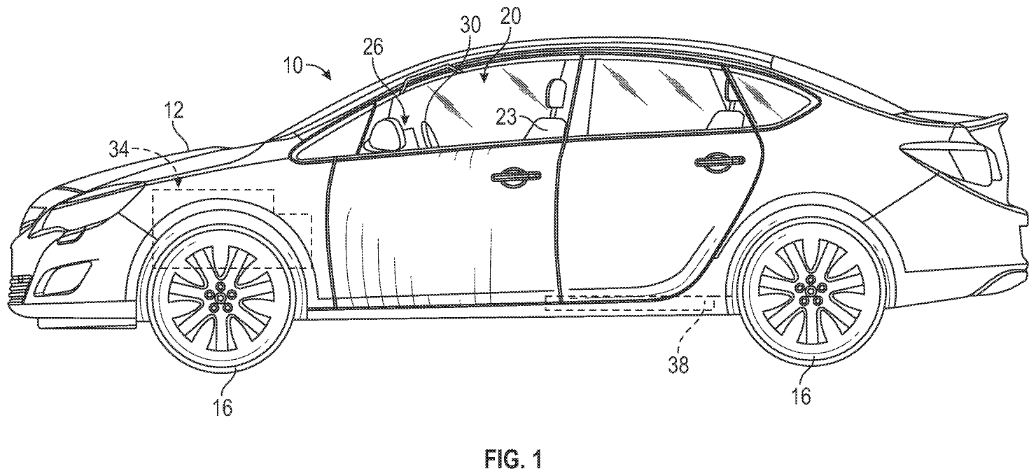

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive motor 34 that provides power to one or more of the plurality of wheels 16.

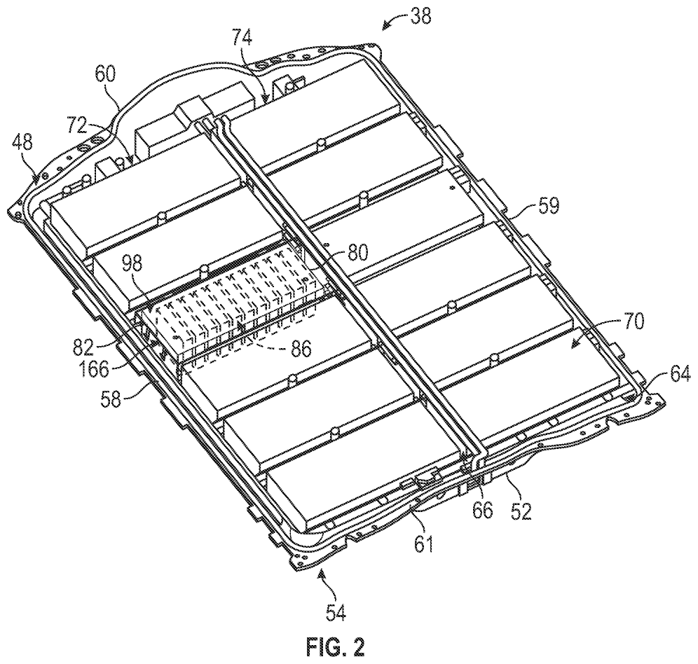

A rechargeable energy storage system (RESS) or battery assembly 38 is arranged in body 12 and provides power to electric drive motor 34. At this point, it should be understood that the location of electric drive motor 34 and battery assembly 38 may vary. Referring to FIG. 2, battery assembly 38 includes a housing 48 including a base wall 52 and a plurality of side walls 54. Side walls 54 include a first side wall 58, a second side wall 59, a third side wall 60, and a fourth side wall 61 that collectively define an interior zone 64. Housing 48 includes a mid-line 66 that extends between third side wall 60 and fourth side wall 61 equally spaced from first side wall 58 and second side wall 59.

In a non-limiting example, a plurality of battery module members 70 are arranged in interior zone 64. Plurality of battery module members 70 are separated into a first plurality of battery modules 72 arranged between mid-line 66 and first side wall 58 and a second plurality of battery modules 74 arranged between mid-line 66 and second side wall 59. In a non-limiting example, each of the plurality of battery module members 70 includes an inboard end 80 arranged at mid-line 66 and an outboard end 82. In a non-limiting example, outboard end 82 of each of the first plurality of battery modules 72 faces first side wall 58 of housing 48 and the outboard end 82 of each of the second plurality of battery modules 74 faces second side wall 59. Each of the plurality of battery module members 70 houses a plurality of battery cells such as indicated at 86.

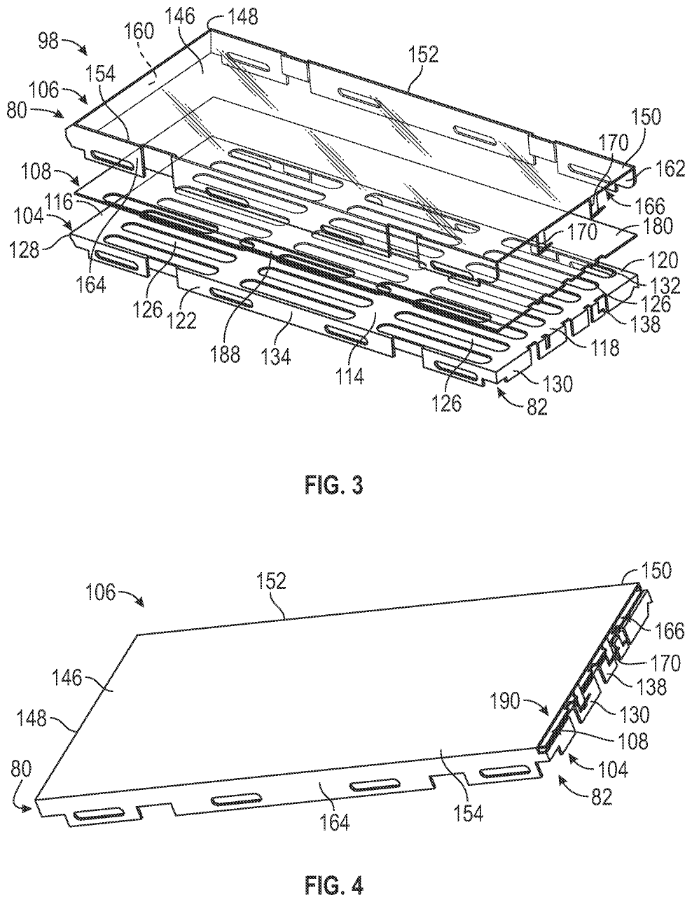

Each of the plurality of battery module members 70 includes a cover assembly 98 that protects battery cells 86 and reduces the ingress of dirt and other objects. In a non-limiting example shown in FIG. 3, cover assembly 98 includes an inner cover member 104, an outer cover member 106, and an intermediate cover member 108. As will be detailed further herein, in addition to protecting battery cells 86, cover assembly 98 contains and channels gasses that may be emitted from battery cells 86 away from adjacent ones of the plurality of battery module members 70 in order to mitigate a thermal runaway event.

With continued reference to FIG. 3, inner cover member 104 includes a surface portion 114 having a first end portion 116, a second end portion 118 opposite the first end portion 116, a first side portion 120, and a second side portion 122 that is opposite to first side portion 120. First side portion 120 and second side portion 122 extend between and connect with first end portion 116 and second end portion 118. Surface portion 114 includes a plurality of openings 126 that may receive and direct gases produced by battery cells 86 outwardly.

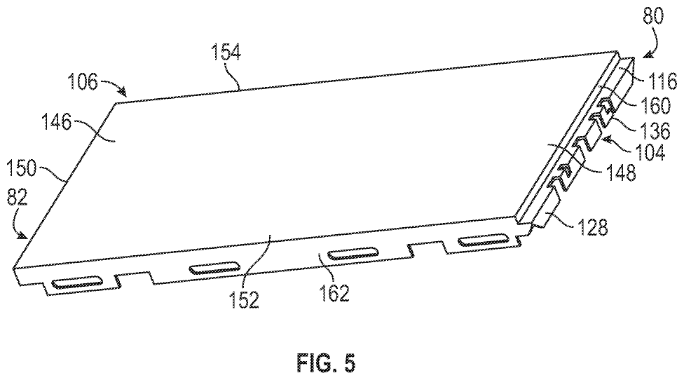

In a non-limiting example, a first end wall member 128 extends from first end portion 116, a second end wall member 130 extends from second end portion 118, a first side wall member 132 extends from first side portion 120, and a second side wall member 134 extends from second side portion 122. First end wall member 128, second end wall member 130, first side wall member 132 and second side wall member 134 connect with an associated one of the plurality of battery module members 70. Towards that end, a first plurality of connector members 136, FIG. 5, are arranged with first end wall 128 and a second plurality of connector members 138 are arranged with second end wall 130. Additional connector members (not separately labeled) may be arranged with first side wall member 132 and second side wall member 134.

Referring to FIGS. 4 and 5, outer cover member 106 includes a surface 146 having a first end 148 and a second end 150 that is opposite first end 148. Surface 146 further includes a first side 152 and a second side 154 that is opposite first side 152. In a non-limiting example, an end wall 160 extends from first end 148, a first side wall 162 extends from first side 152, and a second side wall 164 extends from second side 154.

In a non-limiting example, the absence of an end wall at second end 150 creates a channel 166 that guides any gases that may escape from battery cells 86 away from inboard end 80 and out through outboard end 82 thereby reducing heat buildup at adjacent ones of the plurality of battery module members 70. Channel 166 may guide the gases in in one or multiple directions in order to reduce localized temperatures and mitigate a thermal runaway event. That is, cover 106 may include one or more flow blocking structures, channels and/or depressions that create one or more flow paths that allow gases to quickly escape from channel 166 without being directed toward adjacent modules. In a manner similar to that discussed with inner cover member 104, first end 148 may include a first connector element (not shown) and second end 150 includes second connector elements 170 that secure outer cover member 106 to the associated one of the plurality of battery module members 70.

In a non-limiting example, intermediate cover member 108 is formed from a temperature resistant electrically insulative material such as mica and includes a surface section 180 that is sized and shaped to be substantially similar to surface portion 114 and surface 146. Surface section 180 may include areas of weakness (not separately labeled) that will burst, break, or crack when exposed to gases at a selected temperature and pressure passing from battery cell 86 and through openings 126. Intermediate cover member 108 may also include openings 188 that allows gases to pass. In a non-limiting example, a gap 190 exists between intermediate cover member 108 and outer cover member 106. Gap 190 has a width of about 10-mm and create space that cooperates with channel 166 to guide gases away from other battery modules in order to reduce heat and mitigate an opportunity for a thermal runaway to begin.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly comprising:
a housing including a base wall and a plurality of side walls that are connected to the base wall, the base wall including a mid-line;
a plurality of battery modules arranged between the mid-line and one of the plurality of side walls, each of the plurality of battery modules including an inboard end facing the mid-line and an outboard end facing the one of the plurality of side walls;
a plurality of battery cells arranged in each of the plurality of battery modules; and
a cover assembly mounted on each of the plurality of battery modules, the cover assembly includes an inner cover member and an outer cover member spaced from and connected to the inner cover member, the outer cover member restricting gas flow from the plurality of battery cells to the outboard end.

2. The battery assembly according to claim 1, further comprising an intermediate cover member arranged between the inner cover member and the outer cover member, the intermediate cover member including one or more vent openings.

3. The battery assembly according to claim 2, wherein the outer cover member is spaced from the intermediate cover member.

4. The battery assembly according to claim 3, further comprising a gap having a width of about 10 mm defined between the intermediate cover member and the outer cover member.

5. The battery assembly according to claim 2, wherein the intermediate cover member is formed from a temperature resistant, electrically insulative material.

6. The battery assembly according to claim 1, wherein the outer cover member includes a surface extending across each of the plurality of battery cells, the surface includes a first end arranged at the inboard end, a second end arranged out the outboard end, a first side extending between the first end and the second end, and a second side extending between the first end and the second end, the second side being spaced from the first side.

7. The battery assembly according to claim 6, wherein the outer cover member includes a first end wall extending from the first end of the surface, a first side wall extending from the first side of the surface, and a second side wall extending from the second side of the surface, the first end wall, the first side wall, and the second side wall channeling gases from the plurality of battery cells toward the second end.

8. The battery assembly according to claim 7, wherein the inner cover member includes a surface portion extending across each of the plurality of battery cells, the surface portion includes a first end portion arranged at the inboard end, a second end portion arranged out the outboard end, a first side portion extending between the first end and the second end, and a second side portion extending between the first end portion and the second end portion, the second side portion being spaced from the first side portion by the surface portion.

9. The battery assembly according to claim 8, wherein the inner cover member includes a first end wall member extending from the first end portion of the surface portion, a second end wall member extending from the first end portion of the surface portion, a first side wall member extending from the first side portion of the surface portion, a second side wall member extending from the second side portion of the surface portion, the first side wall member and the second side wall member being connected to the first side wall and the second side wall of the outer cover member.

10. The battery assembly according to claim 6, wherein the second end of the surface includes a connector element connecting the outer cover member with one of the plurality of side walls of the housing.

11. A vehicle comprising:
a body including a passenger compartment;
a drive motor mounted in the body;
a rechargeable energy storage system including a battery assembly mounted to the body, the battery assembly comprising:
a housing including a base wall and a plurality of side walls that are connected to the base wall, the base wall including a mid-line;
a plurality of battery modules arranged between the mid-line and one of the plurality of side walls, each of the plurality of battery modules including an inboard end facing the mid-line and an outboard end facing the one of the plurality of side walls;
a plurality of battery cells arranged in each of the plurality of battery modules; and
a cover assembly mounted on each of the plurality of battery modules, the cover assembly includes an inner cover member and an outer cover member spaced from and connected to the inner cover member, the outer cover member restricting gas flow from the plurality of battery cells to the outboard end.

12. The vehicle according to claim 11, further comprising an intermediate cover member arranged between the inner cover member and the outer cover member, the intermediate cover member including one or more vent openings.

13. The vehicle according to claim 12, wherein the outer cover member is spaced from the intermediate cover member.

14. The vehicle according to claim 13, further comprising a gap having a width of about 10 mm defined between the intermediate cover member and the outer cover member.

15. The vehicle according to claim 12, wherein the intermediate cover member is formed from a temperature resistant electrically insulative material.

16. The vehicle according to claim 11, wherein the outer cover member includes a surface extending across each of the plurality of battery cells, the surface includes a first end arranged at the inboard end, a second end arranged out the outboard end, a first side extending between the first end and the second end, and a second side extending between the first end and the second end, the second side being spaced from the first side.

17. The vehicle according to claim 16, wherein the outer cover member includes a first end wall extending from the first end of the surface, a first side wall extending from the first side of the surface, and a second side wall extending from the second side of the surface, the first end wall, the first side wall, and the second side wall channeling gases from the plurality of battery cells toward the second end.

18. The vehicle according to claim 17, wherein the inner cover member includes a surface portion extending across each of the plurality of battery cells, the surface portion includes a first end portion arranged at the inboard end, a second end portion arranged out the outboard end, a first side portion extending between the first end and the second end, and a second side portion extending between the first end portion and the second end portion, the second side portion being spaced from the first side portion by the surface portion.

19. The vehicle according to claim 18, wherein the inner cover member includes a first end wall member extending from the first end portion of the surface portion, a second end wall member extending from the first end portion of the surface portion, a first side wall member extending from the first side portion of the surface portion, a second side wall member extending from the second side portion of the surface portion, the first side wall member and the second side wall member being connected to the first side wall and the second side wall of the outer cover member.

20. The vehicle according to claim 16, wherein the second end of the surface includes a connector element connecting the outer cover member with one of the plurality of side walls of the housing.
